(19) United States
(12) Patent Application Publication
(10) Pub. No.: US 2002/0095848 A1
(43) Pub. Date: Jul. 25, 2002

(54) Flocked goose decoy

(76) Inventor: William Perry Northouse, Grants Pass, OR (US)

Correspondence Address: KEITH S. BERGMAN, Attorney at Law, Suite 418, 7 South Howard St., Spokane, WA, 99201-3898, US

(21) Appl. No.: 09/766,375

(22) Filed: Jan. 22, 2001

(51) Int. Cl. A01M 31/06

(52) U.S. Cl. 43/3

(57) ABSTRACT

A waterfowl decoy having selected flocked surfaces, especially in black areas, provides intense coloration and prevents light reflection that would indicate artificiality of the decoy. A decoy form having a continuous visually observable peripheral surface is configured and colored to simulate a waterfowl attractive to waterfowl to be decoyed. The surface of the decoy form, especially in selected dark or black areas, is coated with flock material of the same color as the underlying decoy form to provide a flocked surface that has intricacies and irregularities that prevent the reflection of coherent light beams and tend to absorb impinging light. The flock coating is established by covering the area to be flocked with adhesive, establishing flock in a continuous layer to cover the adhesive, and curing the adhesive for positional maintenance of the flock on the decoy form.

### IIA. RELATED APPLICATIONS

There are no applications related hereto heretofore filed in this or any foreign country.

### II. BACKGROUND OF INVENTION

IIB. Field of Invention

This invention relates generally to decoys for attracting waterfowl and more particularly to a decoy for attracting Canadian geese that has dark portions formed by flocked surfaces to simulate natural coloration and prevent unnatural reflection of light therefrom.

IIC. Background and Description of Prior Art

Since many waterfowl, and especially geese, are social by nature and tend to associate with others of their kind, decoys that simulate the appearance of waterfowl have long been used by humans to attract waterfowl, generally of the same type as that simulated, into the vicinity of a user to allow killing, capture, or observation of the attracted waterfowl. This use of decoys undoubtedly originated in prehistoric times and has continued to the present day. Through this historic period waterfowl decoys have been modified and improved until at the present time they are quite sophisticated, but various problems still remain with such decoys. The instant invention seeks to resolve one of those remaining problems.

Waterfowl decoys by their nature are used in outdoor surroundings that commonly are lighted by sun light and in which there often are reflective surfaces such as water, wet vegetation or the like that are light reflective, all to provide a substantial potential for the reflection of light from any reflective surface area of a decoy. As the nature of decoys has improved, they commonly in the present day are manufactured with a potentially smooth surface that is colored to simulate the appearance of a type of waterfowl to be attracted or a type of waterfowl that is attractive to the type of waterfowl to be attracted. These decoys commonly are formed of relatively light durable material of a configurationally sustaining nature such as plastic or similar material which provides a generally continuous curvilinear surface that is of such nature as to be quite reflective of impinging light beams.

The head and upper neck of a Canadian goose is of an intense black color. This black surface portion of the goose is formed by relatively small feathers and down of a fine structure that provide an irregular multi-layered surface with many intricacies and protuberances of varying size that is almost completely non-reflective and even tends to be light absorbing. A goose of the same species or a species that may be attracted by a decoy generally is habitually familiar with seeing this black area in its natural state,so if black areas of a decoy reflect light and this does not appear natural or normal to a viewing goose and may, and generally will, prevent the viewing goose from being deceived as to the real nature of the decoy. This problem has become greater in recent times since the advent of smooth reflective plastic surfaces on decoys and was not a particular problem in older decoys that were formed with rougher more irregular peripheral surfaces which were not particularly light reflective by their nature, whatever their coloration.

The problem of reflective surfaces on Canadian goose decoys has heretofore been recognized and responsively means have been devised to attempt to eliminate light reflections. The most common remedy has been to use some type of colored coating material such as flat paint that provides color but presents a somewhat porous or irregular relatively discontinuous surface that does not shine and is not so conducive to the reflection of light as a surface so smooth as to appear to shine. This remedy has been only partially successful as the colored surfaces are generally somewhat light reflective to provide their colored appearance and their reflectance only tends to lessen the intensity of the coloration. The nature of a decoy surface also may change with use and normal wear which usually tend to make the surface smoother and more light reflective. The use environment also may make a decoy surface more reflective of light by creating a film of water on a somewhat discontinuous surface to make the surface more reflective. Even if a painted or colored decoy surface is not highly or noticeably reflective of light, the intensity of black colors represented on the decoy surface often is not so great as the intensity of the natural black color of the goose and apparently this color variation can be sensed by geese sought to be decoyed. This problem seems to be brought about by the black colored surface of the decoy not being completely non-reflective or light absorbative, so that the surface reflects small amounts of impinging light in random directions to provide an appearance of lightened black coloring that makes black areas look different from the somewhat light absorbative formed by natural feathers and down that are of a very dark black color.

The instant invention seeks to resolve this problem by providing black or dark areas of goose decoys formed by coloring those surfaces with an underlying dark black color and thereafter coating the areas with dark black flock material positionally maintained by an adhesive, preferably at least translucent, that will adhere to the underlying colored surface and positionally maintain the flock material on its outer peripheral surface. The flock material is formed of relatively short chopped fiber of compatible dark black color, from an area that with many intricacies and protuberances or relatively small size that closely approximates the appearance of the natural black feather and down area of a goose. The flock material not only prevents light reflectance, but also tends to trap and absorb impinging light to some extent in somewhat the same fashion as the natural feathered surface to present an appearance that is much more realistic and similar to the appearance of a natural feathered surface than are painted or otherwise colored surfaces of Canadian goose decoys of the present marketplace.

My invention lies not in any of these features individually, but rather in the synergistic combination of all of its structures and processes that necessarily give rise to the functions and uses flowing therefrom as herein specified and claimed.

### III. SUMMARY OF INVENTION

My invention generally provides a peripherally defined decoy with a relatively smooth surface having selected intensely black or very dark colored areas about the head, upper neck and tail covered by black flock material carried over the black colored portions of the decoy periphery a method of forming such colored areas. The method can be used for other dark, naturally non-reflective colored areas of decoys that are not intensely black, though it may not be so effective for such other areas as it is for forming the intensely black areas. To practice my invention I use known decoy blanks having a relatively thin sheet-like peripheral element defining an internal chamber or cavity that may or may not have an opening in some generally unobservable area. Such a configurationally sustaining decoy form is commonly created by molding polymeric material and is colored by painting or staining at least the external surface of the decoy form with coloring material simulating the natural coloration of a waterfowl to be simulated. Selected intensely black portions of the decoy are covered with black flock material by coating the areas with adhesive and then with intensely black flock formed of relatively short chopped fiber. The flock is coated heavily on the adhesive surface to present a visually observable surface formed substantially entirely of flock. The black surface and method of forming it are particularly adapted for use with three dimensional, configurationally sustaining polymeric decoy blanks having relatively smooth peripheral surfaces formed of material that is smooth enough to be at least somewhat reflective of impinging light, though the method is applicable to two dimensional decoys, and the decoys having other decoys having resiliently deformable surfaces such as rubber formed structure and other by types of peripheral surfaces.

In providing such a decoy and method for its formation, it is:

A principal object to provide a three dimensional configurationally sustaining, pre-colored waterfowl decoy, especially to simulate a Canadian goose, having at least selected intensely black colored areas of the decoy formed by flock material of substantially the same color as the underlying color, carried over the black surfaces to present those surfaces in visually realistic fashion.

A further object is to provide such dark colored areas of waterfowl decoys that are formed of non-reflective flock material comprising finely chopped fiber of the desired color that closely simulates the visual appearance of natural feathered surfaces of waterfowl and not only does not reflect impinging light but rather tends to absorb impinging light to make the black areas appear more intensely black.

A further object is to provide such a that has flock surfaces that are durable and formed by flock that is positionally stable so as not to change their intensely colored and non-reflective characteristics over long periods of normal use.

Still further objects are to provide such dark intensely colored non-reflective areas on waterfowl decoys and a method for their creation that are new and novel, of rugged and durable nature, of simple and economic manufacture and use and are otherwise well suited to the uses and purposes for which they are intended.

Other objects of my invention will appear from the following specification and accompanying drawings which form a part hereof. In carrying out the objects of my invention, however, it is to be remembered that its accidental features are susceptible of change in design and structural arrangement with only the preferred practical embodiment being illustrated and specified as is required.

### IV. BRIEF DESCRIPTION OF DRAWINGS

In the accompanying drawings which form a part hereof and wherein like numbers of reference refer to similar parts through:

FIG. 1 is a somewhat generic isometric view of a typical Canadian goose decoy with black areas lined for color.

FIG. 2 is an enlarged cross-sectional view through the peripheral element of the decoy of FIG. 1, taken on the line 2-2 thereon in the direction indicated by the arrows.

FIGS. 3A, 3B and 3C are partial elevational views of the head and neck portions of the decoy of FIG. 1 showing the method of establishment of flock material on selected dark portions of the head and neck.

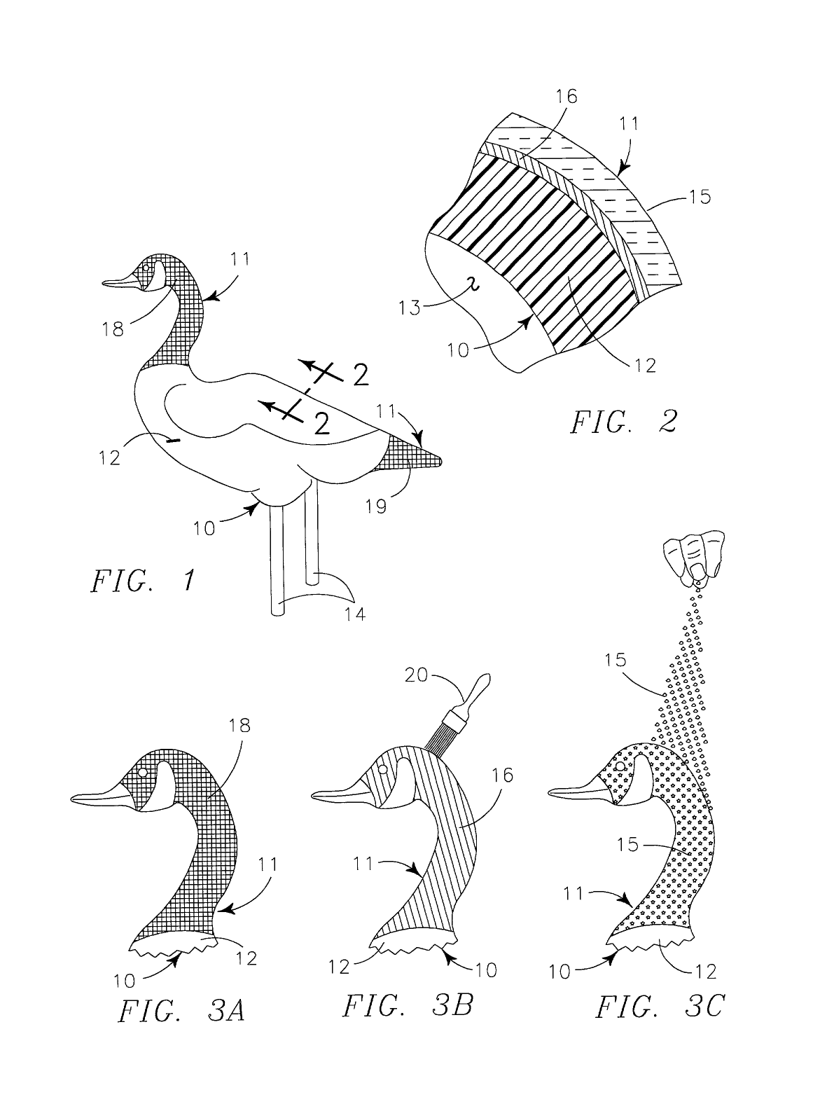

### V. DESCRIPTION OF PREFERRED EMBODIMENT

Referring to the drawings, it will be seen that my invention generally comprises decoy form 10 simulating a Canadian goose with flocked portions 11 representing intensely black areas.

Decoy form 10 is formed by sheet-like configurationally sustaining peripheral element 12 commonly of a molded plastic nature. The peripheral element 12 in modern goose decoys may be easily formed with both gross and detailed peripheral configuration quite accurately simulating an actual goose and it is sometimes so formed, but more commonly the peripheral element will be somewhat more generically formed as the configurational derail is much less important to the proper functioning of the decoy than is its gross generic configuration and coloration. The peripheral element 12 is relatively thin to define internal void 13 to provide economical construction and reduce overall weight to aid handling and transportation of the decoy. The internal void 13 may constitute a chamber with a completely defined periphery or often a lower portion of the peripheral element that is not commonly visible from normal viewing positions of a goose to be decoyed is not completely formed to define an orifice to further reduced the weight and allow access to the internal void of the decoy form, should such access be desired.

The essential gross configuration and coloration of the periphery of decoy form 10 is more important to its functionality then are the details of these elements, probably because of the natural variance of these features. Because of this, the characteristic black and white coloration of a Canadian goose decoy is quite essential to the visual appearance of the decoy is quite specifically defined in most modern decoys both as to visual appearance and boundary. The color commonly is applied to the decoy form after formation by some type of paint-like surface coating or dye that impregnates the surface to provide as much permanence as possible. With modern manufacturing methods the coloration of decoys has often become quite detailed and exacting, beyond the requirements of functionality, and often sufficiently detailed as to confuse a human observer or a goose as to the reality of a decoy.

Some decoy forms provide leg simulating support structures 14 and others do not as commonly a decoy form is placed in an environment where the leg structure is concealed by vegetation or otherwise and not commonly visible to a goose sought to be decoyed. Generally if leg structures are provided they serve primarily as support means and have no foot simulating portion, but rather a bottom no larger than the upper portion of the leg structure to allow easy insertion in the earth.

It is with this generic type of decoy common in the present day marketplace that my flocked dark surfaces are commonly used, though the flock coloration may be used with other types of waterfowl decoys of two dimensional nature, those formed by non-configurationally sustaining covers that are configured by means of some stuffing material, pneumatic pressure or the like and other known types of decoys that present a visual surface defining intensely black or dark portions. The bird referred to herein and generally known as a “Canadian goose” is more eruditely known scientifically as Branta canadensis and it is with this type of goose decoy that my invention is especially operative because of the distinctive light and very dark coloration of this goose.

The natural coloration of the Canadian goose provides a darker back portion and lighter under portion with a very dark, intensely black neck and head portions defining white cheeks and a similar intensely black band of tail feathers. The intensely black portions of the goose, and particularly its head and upper neck, are the areas of the decoy form with which my flock coloring is especially concerned, but flock may be applied to any or all of the darker areas of a Canadian goose decoy or to other intensely colored, non-reflective areas of other types of waterfowl decoys.

Flock portions 11 of my decoy comprise a positionally maintained peripheral surface coating of finely particulated generally fibrous material 15 positionally maintained by an underlying adhesive layer 16 carried by the surface of decoy form 10. Such finely particulated fibrous material is commonly known as “flock” and that term is used in this semantic sense herein. Flock has long been known and commonly created by chopping or grinding fibers of wool, cotton or polymeric material. Such fibers may be colored by traditionally known methods for coloring such material for the making of cloth, such as by dyeing, pigmenting or coating either before or after particulation. Much commercial flock that is available in the present day marketplace is operative with my invention, but such material of preference has a diametrical cross-sectional size between approximately 0.001 to 0.01 inch and a length between 0.01 and 0.10 inch. Flock material outside these ranges is operative with my invention but often not so effectively so as material within the preferred ranges, the effectiveness generally varying somewhat inversely with the flock size. Flock formed of synthetic polymeric fiber appears to be somewhat more durable and to have a longer effective life span, though the effectiveness of preventing light reflection from polymeric fibers that have a smooth peripheral surface maybe somewhat less than from natural fibers or artificial fibers that have a rougher peripheral surface, especially when the flock is in the larger size range. Flock manufactured by Donjer Products, Corp., of 13142 Murphy Road, Winnebago, Ill. and merchandise under its trade name “Suede Tex” has been found quite operative with my invention.

Adhesive 16 must be of such nature as to create an adhesive bond with both the surface material of the decoy form 10 and the flock material. Various commercially available adhesives that are known and used for flocking processes are useable in my process. One adhesive material that has been effectively used is a product manufactured by Donjer Products, Corp., supra, and known by its trade name “Undercoat Adhesive”.

The adhesive preferably should be colored to simulate the color of the underlying supportative surface or be of a transparent or translucent nature so as to enhance the overall visual appearance of the flocked surface in providing the desired colored appearance, especially in any small areas not effectively covered by flock. The adhesive also should provide a non-reflective surface so that any exposed areas will not reflect light to provide any visually observable reflected light beams. With adequate flocking neither coloration nor reflection are problems, as a continuous coating of flock over the adhesive surface prevents any such undesirable effects of the adhesive.

Referring to FIGS. 3A, 3B and 3C, the process of establishment of flock on decoy form 10 may be seen and understood. Firstly, decoy form 10 is created with surface coloration simulating a Canadian goose having black head and neck portions 18 and tail portion 19, both of which are fired for color in the drawings. These portions are pre-colored on the decoy form 10 with a color having a visual appearance approximating that of the black or very dark areas of a natural goose by known coloration processes appropriate to the material from which decoy form 10 is created, such as by dyeing, painting, pigmentation or the like in the case of polymeric materials. The black neck and head portion 18 is coated with adhesive 16 by known coating means, such as manually by use of brush 20 as illustrated in FIG. 3B. The adhesive must by applied in a continuous coat over the surface to be flocked and other known means for applying adhesive that accomplish this end may be used to create the adhesive coating, such as spraying, mask protected dipping, stenciling, printing or the like.

The adhesive after placement must maintain its adhesive capability on its outer surface at least until flock can be established thereon and preferably not much longer. To accomplish this end it may be necessary to establish and regulate the adhesive setting from the time of placement to that of establishment of the flock material. Various methods heretofore known in the adhesive arts are effective for this purpose, such as controlled atmosphere, spraying solvents on the exposed surface, environmental temperature and the like. The adhesive must be carefully established to cover no more than the area within the bounds that are to be flocked, as if uncured adhesive is established elsewhere on the decoy form surface during the flocking process, it may adhere flock material that is hard to remove in undesired places.

Generally because of the environment in which goose decoys are used, the adhesive must not be water soluble or otherwise adversely affected by moisture.

While the outer peripheral surface of the adhesive coat 16 remains in an adherent condition, flock 15 is distributed over the adhesive surface in a uniform manner and in such fashion as to completely cover that adhesive surface as well as possible. Flock as illustrated in FIG. 3C may be manually applied by sprinkling from a worker's fingers 21. Other known methods for placement of flock generally can be used in my process such as spraying in a gaseous stream with some momentum of the flock particles, with or without solvents, cascading, dipping or the like. The coating process is continued until the entire adhesive surface is completely coated with as much flock as it reasonably will accept to provide as continuous, homogenous and thick a flock coating as can be obtained.

After coating with flock the decoy is maintained in a fashion that will not disturb the flock until the adhesive is matured and at least reasonably set. If any particular environment is required for maturation of the adhesive, such as use of a setting agent or a thermal or evaporating environment, that environment is provided and the flocked decoy so that the flock is permanently adhered before any handling that may disturb it.

It is to be noted that flock may be used to cover other than black or dark areas of a decoy and in fact even to cover white areas. Such flock covering is within the ambit, spirit and scope of my invention, but it has been found that flock covering appears to be most effective with intensely colored dark areas and especially the intensely colored black areas of a Canadian goose decoy, as there is substantial difficulty in creating such black areas with a correct visual appearance by any other method.

It is further to be noted that the flock material may be applied to a decoy form that is not pre-colored, with the flock material forming the only coloration. A decoy well and accurately representing any waterfowl, however, is more difficult to create with flocking then by other known coloring processes, and flocking of other intensely colored areas often may not be necessary for adequate functionality of a decoy.

Having thusly described my invention, what I desire to protect by Letters Patent, and

What I claim is:

1. A waterfowl decoy having flocked areas to prevent light reflection, comprising in combination:
a decoy form having configuration and colored peripheral areas simulating the visual appearance of a waterfowl attractive to a waterfowl to be decoyed; and
flock material covering and positionally maintained on at least some colored peripheral areas of the decoy form.

2. The waterfowl decoy of claim 1 further characterized by:
the flock material having substantially the same color as the color of the decoy form therebeneath.

3. The waterfowl decoy of claim 1 further characterized by:
the flock material comprising elongate fiber having cross-sectional dimension of substantially 0.001 to 0.01 inch and length of substantially 0.01 to 0.10 inch.

4. The waterfowl decoy of claim 3 further characterized by:
the flock material comprising fibers of the group consisting of wool, cotton and polymeric material.

5. The waterfowl decoy of claim 1 further characterized by:
the flock material positionally maintained on the peripheral areas of the decoy form by adhesive extending between the flock material and the decoy form.

6. The waterfowl decoy of claim 1 further characterized by:
the decoy form simulating a Canadian goose with substantially black head, neck and tail portions and
at lease one of the substantially black portions of the decoy form covered by flock material having a black color substantially the same as the colored portions of the decoy form.

7. The method of forming a waterfowl decoy having selected colored areas covered by flock comprising in combination,
creating a decoy form simulating the configuration and coloration of a waterfowl;
covering the selected colored areas of the decoy form with adhesive that adheres to the decoy form and to the flock;
covering the surface of the adhesive with flock having substantially the color of the underlying decoy form; and
curing the adhesive to positionally maintain the flock on the underlying decoy form.
